(19) United States
(12) Patent Application Publication
(10) Pub. No.: US 2011/0116612 A1
(43) Pub. Date: May 19, 2011

(54) METHOD AND SYSTEM FOR PROVIDING CALLER INFORMATION

(75) Inventor: FU-SHEN HO, Hsinchu (TW)

(73) Assignee: ALPHA NETWORKS INC., Hsinchu (TW)

(21) Appl. No.: 12/948,379

(22) Filed: Nov. 17, 2010

(30) Foreign Application Priority Data
Nov. 19, 2009 (TW) 098139331

(51) Int. Cl. H04M 1/56

(52) U.S. Cl. 379/142.04

(57) ABSTRACT

A caller information providing system includes a caller device, a database and a receiver device, each of which is in communication with the network. The caller device has an identification code. According to the identification code, caller information of the caller device is provided by the database. The caller information of the caller device provided by the database is acquired through the network, and revealed by the receiver device.

### FIELD OF THE INVENTION

The present invention relates to a method and a system for providing caller information, and more particularly to a method and a system for providing caller information according to an identification code of a caller device.

### BACKGROUND OF THE INVENTION

With increasing development of communication technologies, mobile phones have experienced great growth and are now rapidly gaining in popularity. Recently, the mobile phones have continuously expanded functions and applications such as network services, video applications, GPS (global positioning system) services, or the like. In a case that these applications are used in the mobile phones, the mobile phones need greater security.

For example, before answering an incoming call, the caller number or caller ID is shown on a screen of the mobile phone of the receiver. By viewing the screen, the receiver can identify whether the identity of the caller is known and the caller number has been stored in the mobile phone. As such, the receiver could quickly realize the identity of the caller. Once the identity of the caller is known, the pre-stored picture of the caller may be shown on the screen of the mobile phone, or a ring tune corresponding to the caller is played by the mobile phone.

On the other hand, if the caller number has not been previously stored in the mobile phone of the receiver, the caller number is not included in the address book of the mobile phone of the receiver. In this situation, the receiver fails to realize the caller identity and relevant information (e.g. a caller name, an organization name, a caller address or any other relevant advertisement or information) according to the caller number. Since no related information is realized, the receiver cannot immediately determine whether the incoming call should be received or not because the incoming call may be an important business call or an annoying marketing call or fraud call.

From the above discussions, although the caller number is shown on the screen of the mobile phone of the receiver, the receiver fails to realize the relevant information of the caller.

Therefore, there is a need of providing a method and a system for providing caller information or caller advertisement so as to obviate the drawbacks encountered from the prior art.

### SUMMARY OF THE INVENTION

In accordance with an aspect of the present invention, there is provided a caller information providing method for use with a caller device and a receiver device through a network. Firstly, caller information of the caller device is acquired through the network according to an identification code corresponding to the caller device. Then, the caller information is revealed by the receiver device.

In accordance with another aspect of the present invention, there is provided a caller information providing system for use with a network. The caller information providing system includes a caller device, an inquiry device and a receiver device, each of which is in communication with the network. The caller device has an identification code. According to the identification code, caller information of the caller device is provided by the inquiry device. The caller information of the caller device provided by the inquiry device is acquired through the network, and displayed or broadcasted by the receiver device.

In accordance with a further aspect of the present invention, there is provided a receiver device. The receiver device is in communication with a caller device through a network. The caller device has an identification code. The receiver device includes a transmitting unit, a receiving unit and a display unit. The transmitting unit issues an inquiry request to the network according to the identification code. The receiving unit receives the caller information of the caller device through the network. The display unit is electrically connected with the receiving unit for revealing the caller information.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic functional block diagram illustrating a caller information providing system according to an embodiment of the present invention;

FIGS. 2A-2E are schematic functional block diagrams illustrating several exemplary inquiry devices used in the caller information providing system of the present invention; and

FIG. 3 is a schematic functional block diagram illustrating a receiver device used in the caller information providing system of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

As previously described, if the caller number has not been previously stored in the address book of the mobile phone, the receiver fails to realize the identity of the caller. For obviating the drawbacks encountered from the prior art, the present invention provides a method and a system for providing caller information (e.g. background information of the caller and/or relevant advertisement).

The present invention relates to a caller information providing method for use with a caller device and a receiver device through a network. Firstly, caller information of the caller device is acquired through the network according to an identification code corresponding to the caller device. Then, the caller information is revealed by the receiver device. In accordance with the present invention, the network is a wired network, a wireless network, a homogeneous network or a heterogeneous network (e.g. GPRS, Wifi, 2G, 3G, WiMax, optical fiber, ADSL). In addition, the caller information (e.g. background information and/or the relevant advertisement) is a text message, a picture, a voice message, a short film or the combination thereof.

The present invention also relates to a caller information providing system for use with a network. The caller information providing system includes a caller device including an identification code, a database and/or a search engine, and a receiver device, which are all in communication with the network. According to the identification code, the caller information could be acquired from the database and/or the search engine. The caller information is transmitted to the receiver device through the network, and then displayed on a screen of the receiver device or broadcasted by a loudspeaker of the receiver device. The caller information could be displayed or broadcasted in a dynamic or static manner.

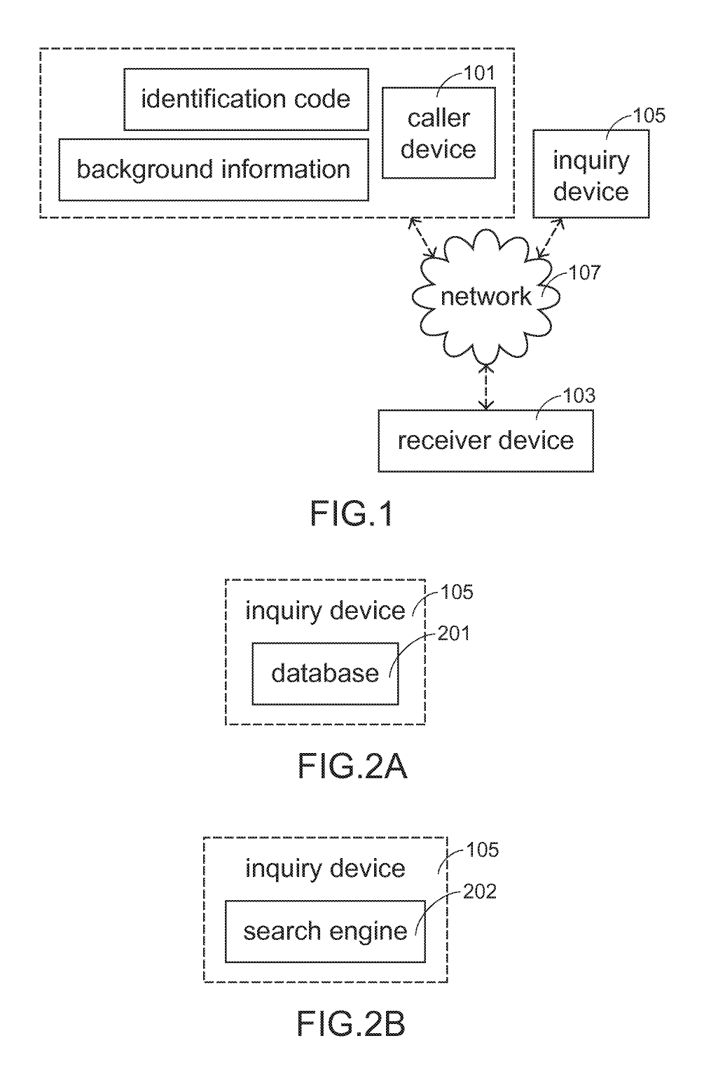

FIG. 1 is a schematic functional block diagram illustrating a caller information providing system according to an embodiment of the present invention. As shown in FIG. 1, the caller information providing system includes a caller device 101, a receiver device 103 and an inquiry device 105, all of which may be in communication with each other through a network 107. The caller device 101 and the receiver device 103 are for example information appliances, telephones, IP phones or mobile electronic devices (such as handheld phones, personal digital assistants or portable computers). An identification code corresponding to the caller device 101 could be transmitted from the caller device 101 to the network 107 or provided by a service provider of the network 107. The identification code is a number, a text or an encoded string.

There are several approaches of providing background information and/or relevant advertisement. For example, in a first approach, when the communication between the caller device 101 and the receiver device 103 is established, the identification code, the background information and/or the relevant advertisement is issued by the caller device 101. In a second approach, when the communication between the caller device 101 and the receiver device 103 is established, the background information and/or the relevant advertisement is inquired by the inquiry device 105. The inquiring result of the background information and/or the relevant advertisement will be transmitted to the receiver device 103 through the network 107. In a third approach, the background information and/or relevant advertisement of the caller device 101 is actively acquired from the network 107 in response to an inquiry request issued by the receiver device 103. In a fourth approach, the background information and/or relevant advertisement is stored in the network and passively received by the receiver device 103, wherein the background information and/or relevant advertisement is actively provided by the caller device 101 or inquired by the inquiry device 105 and transmitted to the network.

In other words, the background information and/or relevant advertisement could be actively provided by the caller device when the communication between the caller device and the receiver device is established. Alternatively, the background information and/or the relevant advertisement could be inquired by the inquiry device when the communication between the caller device and the receiver device is established. Alternatively, the background information and/or the relevant advertisement could be passively received by the receiver device. Alternatively, the background information and/or relevant advertisement could be inquired by the inquiry device according to the identification code.

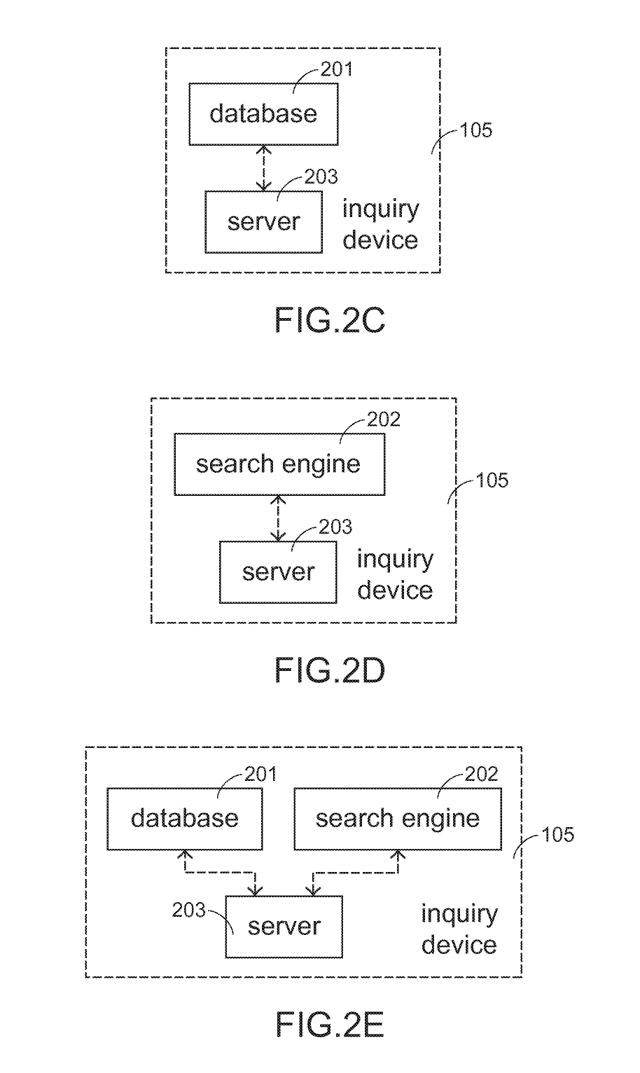

FIGS. 2A-2E are schematic functional block diagrams illustrating several exemplary inquiry devices used in the caller information providing system of the present invention.

As shown in FIG. 2A, the inquiry device 105 includes a database 201. The database 201 includes a caller database and/or a relevant advertisement database, which are provided by the network service provider. The background information and/or relevant advertisement of the caller device may be previously registered into the database 201 in order to enhance the advertising efficacy.

As shown in FIG. 2B, the inquiry device 105 includes a search engine 202 for performing an internet searching operation. For example, Google and Yahoo are common search engines for internet searching. The identification code of the caller device is a keyword inputted into the search box of the search engine 202. After the internet searching operation is performed, the information related to the caller device will be listed. For increasing the on-line advertising service scope, the advertising service provided by the search engine (e.g. Google Ads) may be cooperatively used.

As shown in FIG. 2C, the inquiry device 105 includes a database 201 and a server 203. The server 203 is used for facilitate processing the inquiry request. By using the identification code of the caller device as a keyword, the background information and/or relevant advertisement associated with the caller device will be searched from the database 201. The searching result of the background information and/or the relevant advertisement will be transmitted to the receiver device 103 through the network 107. By the way, the service provider of several specific servers 203 may collect fees from the advertisement provider.

As shown in FIG. 2D, the inquiry device 105 includes a search engine 202 and a server 203. The server 203 is used for facilitate processing the inquiry request. By using the identification code of the caller device as a keyword, the background information and/or relevant advertisement associated with the caller device will be searched by the search engine 202. The searching result of the background information and/or the relevant advertisement will be transmitted to the receiver device 103 through the network 107. By the way, the service provider of several specific servers 203 may collect fees from the advertisement provider.

As shown in FIG. 2E, the inquiry device 105 includes a database 201, a search engine 202 and a server 203. The database 201 is a fee-charging database. The search engine 202 is a free-of-charge search engine. The server 203 is a communication medium between the network 107 and the database 201 and the search engine 202. The server 203 could search the caller's background information from the search engine 202 by using the identification code of the caller device as a keyword. In addition, the server 203 could inquire the caller database or the advertisement database by using the identification code of the caller device as a keyword. Once the searching result is transmitted to the receiver device 103, the caller information is dynamically or statically shown on a display unit of the receiver device 103. By the way, the service provider of several specific servers 203 may collect fees from the advertisement provider. Although the database 201 and the search engine 202 are included in the inquiry device 105 in FIG. 2E, it is not limited to this embodiment. The inquiry device 105 may be in communication with an external database or an external search engine through the network 107 based on cloud computing technology. The inquiring principals are the same as those described above.

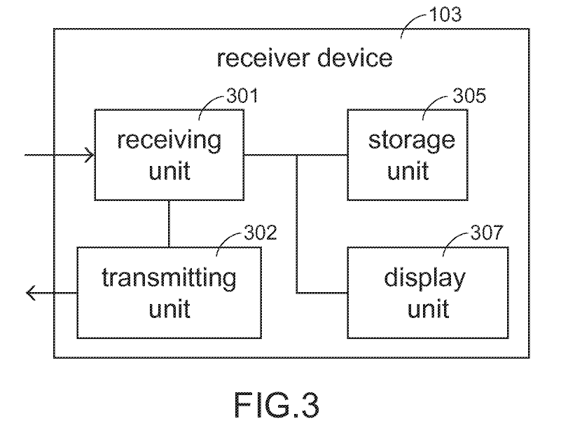

FIG. 3 is a schematic functional block diagram illustrating a receiver device used in the caller information providing system of the present invention. As shown in FIG. 3, the receiver device 103 includes a receiving unit 301, a transmitting unit 302 and a display unit 307, which are electrically connected with each other. Alternatively, the functions of the transmitting unit 302 and the receiving unit 301 may be integrated into a transceiver module.

By the transmitting unit 302, an inquiry request is transmitted from the receiver device 103 to the network 107. In response to the inquiry request, the caller information is acquired by the receiver device 103 according to the identification code of the caller device 101. The receiving unit 301 is used for receiving the caller information through the network 107. The caller information is a text message, a picture, a voice message, a (short) film or the combination thereof. That is, the caller information is displayed or broadcasted in video or audio format through the display unit 307 or an audio output unit (not shown). Optionally, the receiver device 103 includes a storage unit 305 for storing the caller information in the address book or database of the receiver device 103. Caller information of any new call will be compared with the stored information to output corresponding video or audio signals.

In the above embodiments, the caller information providing method of the present invention is capable of inquiring the caller information from the database or the network by using the identification code of the caller device 101 as the keyword. The caller information of the caller device 101 includes for example a caller name, an organization name, a caller address or any other relevant advertisement or information. The caller information will be revealed by the receiver device 103 in real time. When the receiver device 103 is in communication with the caller device 101, the background information and/or relevant advertisement of the caller device 101 could be inquired in real time, and displayed or broadcasted by the receiver device 103 in a video or audio format. According to the background information and/or relevant advertisement of the caller device 101, the receiver could determine whether the incoming call should be received or not.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A caller information providing method for use with a caller device and a receiver device through a network, the caller information providing method comprising steps of:
acquiring caller information of the caller device through the network according to an identification code corresponding to the caller device; and
revealing the caller information by the receiver device.

2. The caller information providing method according to claim 1 wherein when the communication between the caller device and the network is established, the identification code is transmitted to the network from the caller device or provided by a service provider of the network, and the identification code is transmitted to the receiver device through the network.

3. The caller information providing method according to claim 1 wherein an inquiry request is transmitted from the receiver device to the network according to the identification code, and in response to the inquiry request, the caller information of the caller device is acquired by the receiver device through the network.

4. The caller information providing method according to claim 1 wherein the identification code and the caller information are transmitted from the caller device to the network, and the caller information of the caller device is acquired by the receiver device through the network according to the identification code, or wherein the caller information of the caller device is provided by a service provider of the network according to the identification code, and the caller information of the caller device is acquired through the network, or wherein the caller information of the caller device is provided by a database that is connected to the network according to the identification code, and the caller information of the caller device is transmitted through the network.

5. The caller information providing method according to claim 1 wherein after the identification code is received by the receiver device, an inquiry request is transmitted from the receiver device to the network according to the identification code, and in response to the inquiry request, the caller information of the caller device is acquired by the receiver device through the network.

6. The caller information providing method according to claim 1 wherein the caller information includes background information of a caller or relevant advertisement of the caller.

7. A caller information providing system for use with a network, the caller information providing system comprising:
a caller device in communication with the network, wherein the caller device has an identification code;
an inquiry device in communication with the network, wherein caller information of the caller device is provided by the inquiry device according to the identification code; and
a receiver device in communication with the network wherein the caller information of the caller device provided by the inquiry device is acquired through the network, and revealed by the receiver device.

8. The caller information providing system according to claim 7 wherein the caller information providing system further comprises a server, which is in communication with the network and used as a communication medium between the network and the inquiry device.

9. The caller information providing system according to claim 7 wherein each of the caller device and the receiver device is an information appliance, a telephone, an IP phone, a handheld phone, a personal digital assistant or a portable computer.

10. The caller information providing system according to claim 7 wherein the identification code of the caller device is a number, a text or an encoded string.

11. The caller information providing system according to claim 7 wherein the inquiry device includes a database or a search engine or the inquiry device is in communication with an external database or an external search engine through the network.

12. The caller information providing system according to claim 11 wherein the database is a caller database or an advertisement database.

13. The caller information providing system according to claim 7 wherein the receiver device comprises:
a transmitting unit in communication with the network for issuing an inquiry request to the network according to the identification code;
a receiving unit in communication with the network and electrically connected to the transmitting unit for receiving the caller information of the caller device through the network; and
a display unit electrically connected with the receiving unit for revealing the caller information.

14. The caller information providing system according to claim 7 wherein the caller information includes background information of a caller or relevant advertisement of the caller.

15. A receiver device in communication with a caller device through a network, the caller device having an identification code, the receiver device comprising:
a transmitting unit in communication with the network for issuing an inquiry request to the network according to the identification code;
a receiving unit in communication with the network and electrically connected to the transmitting unit for receiving the caller information of the caller device through the network; and
a display unit electrically connected with the receiving unit for revealing the caller information.

16. The receiver device according to claim 15 wherein the caller information is displayed or broadcasted by the display unit in a video or audio format

17. The receiver device according to claim 15 wherein the receiver device is an information appliance, a telephone, an IP phone, a handheld phone, a personal digital assistant or a portable computer.

18. The receiver device according to claim 15 wherein in response to the inquiry request, the caller information of the caller device is acquired by a database that is connected to the network.

19. The receiver device according to claim 15 wherein the caller information is a text message, a picture, a voice message, a film or a combination thereof.

20. The receiver device according to claim 15, further comprising a storage unit electrically connected to the receiving unit for storing the caller information of the caller device.
